(19) United States
(12) Patent Application Publication
(10) Pub. No.: US 2013/0065723 A1
(43) Pub. Date: Mar. 14, 2013

(54) Regulating the work output speed of an infinitely variable transmission using the rotational resistance created by a high-voltage alternator/generator mechanically connected to a secondary output shaft or gear from the IVT to restrain its rotation

(71) Applicant: Ross George Haldeman, Albuquerque, NM (US)

(72) Inventor: Ross George Haldeman, Albuquerque, NM (US)

(73) Assignee: Ross George Haldeman, Albuquerque, NM (US)

(21) Appl. No.: 13/573,879

(22) Filed: Oct. 11, 2012

Related U.S. Application Data
(63) Continuation of application No. 12/931,798, filed on Feb. 8, 2011, now abandoned.

(51) Int. Cl. F16H 3/72

(52) U.S. Cl. 475/154

(57) ABSTRACT

This present invention uses the rotational resistance created by a high-voltage alternator/generator to regulate the speed of the primary work output shaft in an Infinitely Variable Transmission. This will be accomplished by mechanically and rotationally attaching the high-voltage alternator/generator to a secondary output shaft or gear in the IVT. Sending a signal to the high-voltage alternator/generator to create electricity will create rotational resistance against the secondary output shaft or gear, slowing the rotation of the secondary output shaft or gear and causing the primary work output shaft to speed up. The greater the electrical load that is applied to the high-voltage alternator/generator, the faster the primary work output shaft will turn. The lesser the electrical load, the slower the primary work output shaft will turn.

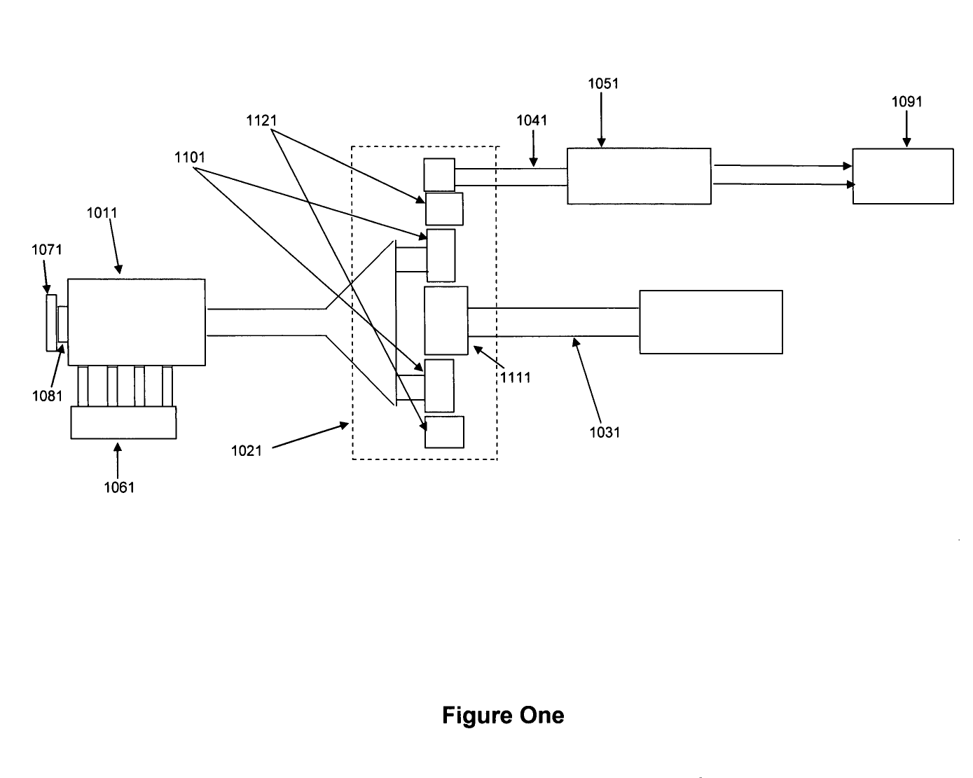

### CROSS REFERENCE TO RELATED APPLICATIONS

THIS APPLICATION CLAIMS THE BENEFIT OF PPA Ser. No. 61/456,456, FILED Nov. 5, 2010 AND application Ser. No. 12/931,798 FILED Feb. 8, 2011 BY THE PRESENT INVENTOR, WHICH ARE INCORPORATED BY REFERENCE

### STATEMENT REGARDING FEDERALLY SPONSORED RESEARCH AND DEVELOPMENT

NOT APPLICABLE

### NAMES OF THE PARTIES TO A JOINT RESEARCH AGREEMENT

NOT APPLICABLE

### INCORPORATION-BY-REFERENCE OF MATERIAL SUBMITTED ON A COMPACT DISC

NOT APPLICABLE

### BACKGROUND ART

U.S. Patent Documents

| | | | |
|---|---|---|---|
| 01. | 4,583,423 | Apr. 22, 1986 | Hahne |
| 02. | 4,610,184 | Sep. 09, 1986 | Taylor |
| 03. | 6,132,330 | Oct. 17, 2000 | Leggett |
| 04. | 6,338,692 | Jan. 15, 2002 | Magyari |
| 05. | 6,616,564 | Sep. 09, 2003 | Shibukawa |
| 06. | 6,849,023 | Feb. 01, 2005 | Kerr |
| 07. | 6,994,646 | Feb. 07, 2006 | Ai |
| 08. | 7,213,389 | May 08, 2007 | Teijido; et al. |
| 09. | 7,614,973 | Nov. 10, 2009 | Parthuisot; et al. |
| 10. | 20090163319 | Jun. 25, 2009 | Janasek |
| 11. | 20090149296 | Jun. 11, 2009 | Eastman; et al. |
| 12. | 20080269008 | Oct. 30, 2008 | Magyari |
| 13. | 20080269001 | Oct. 30, 2008 | Greenwood; et al. |
| 14. | 20080146414 | Jun. 19, 2008 | Pognant-Gros; et al. |
| 15. | 20080132372 | Jun. 05, 2005 | Baumann |
| 16. | 20070240962 | Oct. 18, 2007 | Parthuisot; et al. |
| 17. | 20060118346 | Jun. 08, 2006 | Rampen; et al. |
| 18. | 20040043856 | Mar. 04, 2004 | Xiaolan |
| 19. | 20040025611 | Feb. 12, 2004 | Naude |

### BACKGROUND OF INVENTION

My first understanding of a mechanical, all-gear infinitely variable transmission, (IVT), occurred when I saw where a company was using what was described to me as a hydraulic motor to control the speed of the ring gear of a planetary gear set to regulate the work output speed of the sun gear of their new IVT. Slowing the ring gear will speed up the sun gear, which is attached to the primary work output shaft. Allowing the ring gear to speed up will cause the sun gear to turn slower, thus slowing the vehicle. This concept seems to be consistent in the IVT patents and applications I looked at. Most IVTs refer to using a hydraulic motor connected to a secondary output shaft or gear to regulate the rotational speed of the primary work output shaft.

Later, I learned of a company that brought out a new hybrid version of an existing model automobile that uses an IVT. This hybrid vehicle has a larger displacement gas engine than the non-hybrid version and, when combined with the electrical portion, produces 23% more horsepower but is only slightly faster in a zero to sixty mph run. I decided to research to see what kind of IVT they were using to learn where this inefficiency existed. I learned they were using a brake mechanism to regulate the secondary output shaft in their IVT in order to control the work rotational speed. To slow the vehicle, the braking force on the secondary output shaft would be reduced, allowing the secondary output shaft to spin faster and the primary work output shaft to turn slower. To increase vehicle speed, this process would be reversed. The braking to control the rotation results in the inefficiencies seen in the company's literature. I thought back to the first IVT I saw and realized the term hydraulic motor, which was given to me, was most likely incorrect. For the vast majority of the time, it would be a hydraulic pump. I could see that if this pump/motor, or brake, were replaced with a high-voltage alternator/generator mechanically attached to the secondary output shaft or gear of an IVT, I would be able to have the computer controlling the electrical load applied against the high-voltage alternator/generator creating rotational resistance. This alternator/generator of the present application will regulate the work output speed and will provide a source of abundant electrical energy to power the computer-controlled electric super charger in my patent application Ser. No. 12/802,348 as well as adding electrical energy to the electric hybrid combination that is so common, and to other engine accessories. This present invention will do away with the serious energy losses common to all-gear IVTs, which is why they are not popular, even if they are far more reliable than the Vee-belt driven continuously variable transmissions, (CVT). The electric energy available will be in relation to the demand for its consumption because the greater the work being done by the vehicle or equipment, the greater the restraining force that must be applied by the high-voltage alternator/generator against the secondary output shaft or gear in order to maintain the desired output speed of the primary work output shaft, thus creating more electrical energy.

As I have pointed out in my patent application Ser. No. 12/802,348, the demand for more fuel-efficient engines for all applications will increase. The computer controlled electric super charger will be a more efficient and more easily controlled means of creating boost to a combustion engine than the current turbo chargers. If we get the electrical energy to operate it from the energy currently wasted in most IVTs, the increase in efficiency will add considerably to the overall efficiency of the vehicle or equipment. As it is, turbo chargers only react to greater amounts of fuel, while the computer-controlled, high-voltage electric super charger simply reacts to a command from the computer to supply more boost.

1. Field of the Invention

The field of the present invention is to regulate the primary work output shaft of an IVT by mechanically connecting a high-voltage alternator/generator to a secondary output shaft or gear. The resistance created from the generation of electrical energy will restrain the rotation of this secondary output shaft or gear. The greater the rotational resistance from the electrical generating load applied against this secondary shaft or gear will cause the secondary output shaft or gear to turn slower and thus speed up the primary work output shaft. Conversely, the lower the electrical generating load applied, the faster the secondary output shaft or gear will turn, thus causing the primary work output shaft to turn slower.

2. Discussion of Background Art

Since the first means of mechanical propulsion came into existence, there has been the need for the ability to change gear ratios between the source of propulsion, hereafter called the combustion engine or primary energy source, and the final drive mechanism. The less powerful the engine, the greater the need to have more gear ratios to select from. In times past, vehicles were able to use large engines to overcome the need for many gear ratios. While this worked from a performance point of view, these large engines rarely worked at their optimal point of efficiency due to the inability to constantly remain at this optimal point of efficiency and thus they were inefficient.

As fuel prices have sky rocketed in recent years, there has been great interest, and a serious need, to improve fuel economy. Most companies have resorted to smaller engines in an effort to improve fuel economy, creating a need for many more gears as these smaller less powerful engines do not have low speed torque to pull well at any speed below their optimal point of operation, which is too fast for maximum fuel efficiency. These engines are operating too fast to allow time for complete combustion at the peak of the compression cycle. The rate of combustion does not speed up just because the engine does. This explains why today's vehicles with smaller engines basically do not get any better fuel economy than the same weight vehicle did 50 years ago. Some manufacturers have resorted to transmissions with many gears. But even with a large selection of gearing, these smaller engines are too often out of their optimal point of operation with every gear change. This has brought about a new interest in using transmissions with an infinite number of gear ratios to select from. However, as is seen in the automotive application mentioned above, this has not worked out well with the all-gear IVTs because there is too much input energy wasted by the restraint applied to the secondary output shaft or gear to force the primary output shaft to turn. The waste of this energy can more than offset any efficiency gained by infinite gearing to keep the primary energy source at its optimal operating speed.

Some of the earliest transmissions of this type, often referred to as a CVT, use a type of v-belt or v-chain drive where one side of the pulley on each end of the loop can move in or out in opposite directions in relation to the stationary side, forcing the v-belt or v-chain to move closer to or further from the center of the pulleys. The movement of the belt placement deeper in one pulley and shallower in the other pulley, or the reverse of this placement is what makes the constantly variable ratios possible. This design can be seen in Patent number 01 above. Patent number 15 above refers to a belt rotating around a series of arms that can move in and out, changing the circumference the belt travels on. Again, this will allow for constantly variable ratios to be possible. Both of these designs depend on a belt for the transmission of large amounts of energy. Belts can be quite efficient, but their life is not long and so they will require frequent maintenance. Secondly, neither of these belt designs allows for a great range of ratios because their minimum and maximum ratios are limited by the total effective change in pulley diameter.

Other designs, such as 04, 05, and 12 above, depend on the bending of metal, either as needles or as a shaft to allow different points of contact to create the different ratios. Both of these designs can be plagued by metal fatigue, and their range of ratios will be limited by the maximum change afforded within their contact range.

Some designs, such as 07 and 09 above, use a combination of a number of planetary gear sets and multiple electric motors/generators to provide a wider range of gear ratios. These designs will be expensive to build and maintain due to their complexity.

The application in 17 above refers to a simple hydraulic system where a variable displacement hydraulic pump drives a variable displacement hydraulic motor. It is not possible to develop a wide range of ratios from this because the displacement of the variable pump and motor will limit the range. This system may also be plagued with heating problems, especially in higher speed applications.

All these, as well as the others I have listed, serve to show the amount of work, variety, and thought that is being put into accomplishing a reliable IVT.

In summary, the force required to move a vehicle using the current fixed-gear ratio transmissions is between at least two geared shafts, where the force against one gear being rotated by a primary energy source is transferred to a second gear that will rotate the work output shaft (the only output pathway), which does not want to move because of the load placed against it. In an IVT, there is additional gearing so that the input energy may have two possible rotational output pathways. In one example of this, if the primary work output shaft is connected to the drive mechanism of a machine, this shaft will resist movement due to the work load. This will transfer the rotational energy to the secondary output shaft or gear causing it to rotate, providing that the input rotational speed from the primary energy source remains constant. In another example, the unrestrained ring gear of a planetary gear set, being the secondary output gear, will want to spin while the sun gear connected to the work output shaft resists turning due to the work load. In both of these examples, controlling the rotational speed of the secondary output shaft or gear by applying a restraint with a high-voltage alternator/generator in this present invention will result in the primary energy being transferred from the input shaft of the primary energy source to the primary work output shaft at a controllable speed. Allowing the secondary output shaft or gear to rotate freely will result in the primary work output shaft to stop rotating. Some companies using this technology are using hydraulics to create the resistance to control the rotational speed of the secondary output shaft or gear. However, if they are generating hydraulic energy, the need for hydraulic energy is generally not very great for the majority of normal operating situations. Some companies and patent applications are using some type of brake to regulate the speed of the secondary output shaft or gear. Both of these examples waste energy as well as creating great amounts of heat requiring large heat sinks to dissipate this heat. This present invention currently being considered will allow using this mostly wasted energy by converting it to high-voltage electricity to power such things as engine accessories, electric super charger, and/or supplementing the electric energy in a hybrid form of propulsion, as well as future vehicle electrical needs.

### SUMMARY OF THE INVENTION

In patent application Ser. No. 12/802,348, one of the points I make is that the generation of electrical energy to drive the high-voltage electric super charger will be more efficient than creating rotational energy from air passing over the turbine blades of the turbo charger. This point was made with the idea of using a belt-driven, high-voltage alternator/generator to supply the electricity to operate the super charger and other accessories. Now, with this present invention using a high-voltage alternator/generator to regulate the speed of the secondary output shaft or gear, which regulates the output speed of the primary work output shaft or gear, we can convert energy, which has truly been wasted most of the time with IVT transmissions, into high-voltage electricity to power all kinds of electrical accessories. IVT transmissions have not caught on because there is too much energy wasted when an inefficient restraint is placed against the secondary output shaft or gear in order to make the primary output shaft turn. In the case of the first IVT I saw, if the motor shown to me was in reality a hydraulic pump, the machine this IVT was in could use this hydraulic energy only part of the time. Most of the time the vast majority of this available hydraulic energy would simply be wasted since there would be little use for it and the heat created by the unused high-pressure fluid would have to be dissipated.

In the example of the hybrid car discussed in the Back Ground of the Invention, this present invention would do away with the inefficiencies which are seen in the manufacturer's literature due to the input energy losses from using a brake mechanism to restrain rotation of a secondary output shaft or gear inside the transmission. In this present invention the high-voltage electrical energy created by this present invention could be fed into the electric hybrid portion of this vehicle. This would make it more efficient both in performance and in fuel mileage by using the energy currently lost due to the brake in the transmission and convert that loss to electricity to power the electric motor in the hybrid portion. If this hybrid vehicle were using the high-voltage electrically driven super charger in application Ser. No. 12/802,348 to create a high level of intake manifold boost and the high-voltage electric alternator/generator in this present invention to regulate the speed of the secondary output gear in the IVT instead of a brake, this vehicle would be capable of fuel mileage seriously exceeding the 23 mpg as shown in the company's literature, with performance exceeding many sports cars.

This has been an exciting thought to be able to combine these two applications, application Ser. No. 12/802,348 and this present invention, to greatly reduce our dependence on foreign oil while at the same time giving us vehicles with superb performance that weigh enough so they can be built strongly to protect the occupants in case of an accident and to also provide the weight to help hold the vehicle steady on slippery roads and in high wind situations.

### DESCRIPTION OF FIGURE ONE

Figure One is a drawing representing a planetary gear set where the ring gear is not fixed, but is allowed to turn freely. A high-voltage alternator/generator is mechanically attached to this ring gear to regulate its rotational speed. While this might be the preferred embodiment, it does not represent the total variations of gear transmissions on which it could be used.

### DETAILED DESCRIPTION OF DRAWING

In Figure One, the energy begins in (1011), the combustion engine or other primary energy source. This rotational energy is mechanically connected to the planet gears (1101) inside the mechanical planetary gear box (1021). For this example, the rotational speed from the primary energy source (1011) entering the mechanical gear box (1021) will remain constant. Inside the gear box (1021), there will be two possible directions this energy input may be directed. One will be through the sun gear (1111), to the primary work output shaft (1031). The second will be through the ring gear (1121) to the secondary output shaft (1041). Because (1031) is the primary work output shaft, it will resist rotation. If no means of controlling the ring gear (1121) is used, it will be the only output gear to turn and all energy will be directed to it. The present invention uses a high-voltage alternator/generator (1051) attached to this secondary output shaft (1041) driven by the ring gear (1121). If we create an electrical load against the high-voltage alternator/generator (1051), this will cause the high-voltage alternator/generator (1051) to pull hard, resisting rotation. This will result in the high-voltage alternator/generator (1051) restraining the rotation of the secondary output shaft (1041) and thus the ring gear (1121) and transfer the rotational energy delivered to the planet gears (1101) to the sun gear (1111) and then to the primary work output shaft (1031). By increasing the electrical load on the high-voltage alternator/generator (1051), the secondary output shaft (1041) will slow the ring gear (1121) down and cause the sun gear (1111) to speed up and thus the primary work output shaft (1031) to speed up. By reducing the electrical load on the high-voltage alternator/generator (1051), the secondary output shaft (1041) will speed up, allowing the ring gear (1121) to speed up. This will cause the sun gear (1111) to slow down and thus the primary work output shaft (1031) will rotate more slowly. The greater the amount of work being done by the primary work output shaft (1031), the greater the electrical load that must be applied to the high-voltage alternator/generator (1051) to restrain the ring gear (1121) in order to maintain the desired speed of the primary work output shaft (1031).

Also, the greater the work load against the primary energy source (1011) coming through the mechanical gear box (1021), the greater the need for electrical energy to speed up the high-voltage, electric-driven super charger (1061) as seen in application Ser. No. 12/802,348, to increase the intake manifold boost to the primary energy source (1011). In addition, the greater the demand for electrical energy coming from the electrical side of a hybrid design (1091), the greater the need for electric energy from the high-voltage alternator/generator (1051). In the above example, the increased work load being done by the primary work output shaft (1031) transferred through the mechanical gear box (1021) to the primary energy source (1011) will also require more electrical energy to operate the electric fan (1071) and the electric water pump (1081) to keep the primary energy source (1011) properly cooled. So as the load increases against the primary energy source (1011), a greater electrical load must be created against the high-voltage alternator/generator (1051) in order to restrain the tendency of the ring gear (1121) to speed up, which would allow the sun gear (1111) to slow down or stop. This situation causes the creation of high-voltage electricity in the alternator/generator (1051) in proportion to the demand for it. Through proper gearing between the ring gear (1121) and the secondary output shaft (1041) and the sizing of the high-voltage alternator/generator (1051), there can be enough rotational resistance applied against the ring gear (1121) to control its speed, thus regulating the final output speed of the primary work output shaft (1031).

### DETAILED DESCRIPTION

In an all-gear IVT, there will be a shaft or gear which could be used as a secondary output. If this shaft or gear is not restrained when energy from the primary energy source is directed to the IVT, it will simply spin freely when there is a work load applied against the primary work output shaft. This has been the main problem in using an IVT because so much of the input energy is wasted due to inefficient restraints applied to the secondary output shaft or gear. This present invention will mechanically attach a high-voltage alternator/generator to this secondary output shaft or gear. Applying an electrical load to the high-voltage alternator/generator will create the restraining force needed to control the rotation of the secondary output shaft or gear and thus cause the primary work output shaft to rotate at a controlled rate of speed. Therefore, regulating the electrical load against the high-voltage alternator/generator will result in regulating the output speed of the primary work output shaft. A greater electrical load will result in greater rotational resistance against the secondary output shaft or gear, resulting in a faster rotation of the primary work output shaft. A lesser electrical load will be the reverse of the above and will cause a slower speed of the primary work output shaft.

The above phenomena will work well in any vehicle or equipment. As the work load increases against the IVT, it will require a greater rotational resistance against the secondary output shaft or gear to keep the work output shaft rotating at the desired speed. This greater rotational resistance being applied by the high-voltage alternator/generator against the secondary output shaft or gear will result in increased electrical production. This will coincide with the greater need for electrical energy to speed up the high-voltage electric super charger (in application Ser. No. 12/802,348) to create a higher intake manifold boost pressure, causing the combustion engine to develop higher horsepower to meet the increased work load. Other engine accessories such as electrically driven water pumps and cooling fans will also require more electrical energy to meet the cooling needs resulting from the increased work load. As the work load is increased in the typical hybrid vehicle, the increased electrical energy generated from restraining the secondary output shaft or gear can be fed into the battery pack, where it would be available to power the electric motor, adding more energy to the primary work output shaft.

The invention claimed is:

1. Using the rotational resistance created by a high-voltage alternator/generator mechanically and rotationally connected to a secondary output shaft or gear on an IVT to regulate the rotational speed of the primary work output shaft while maintaining the input rotational speed constant coming from the primary energy source. An IVT must have a secondary output shaft or gear mechanically connected to the primary work output shaft or gear which must be restrained in order to cause the primary work output shaft to turn. One example of this would be regulating the speed of the ring gear (the secondary output gear) of a planetary gear set, to cause the sun gear, the primary work output gear, to rotate at the desired speed. The faster the ring gear is allowed to turn when rotational energy from the primary energy source is applied to the planet gears, the slower the sun gear will turn. If the ring gear is not restrained, it will spin freely and the sun gear, being the primary work output gear, will not rotate. In the present invention, the high-voltage alternator/generator would be connected rotationally and mechanically to the ring gear.

2. Applying an electrical load or increasing the electrical load to the high-voltage alternator/generator in claim 1 will create increased resistance against the rotation of the secondary output shaft or gear, causing it to slow down. This will cause the primary work output shaft to speed up while the primary input shaft rotational speed is held constant.

3. Reducing the electrical load to the high-voltage alternator/generator in claim 1 will reduce the resistance against the rotation of the secondary output shaft or gear, allowing the secondary output shaft or gear to speed up and causing the primary work output shaft to slow down while the primary input shaft rotational speed is held constant.

4. Removing the electrical load to the high-voltage alternator/generator in claim 1 will allow the secondary output shaft or gear to turn freely, causing the primary work output shaft to stop rotating while the primary input shaft rotational speed is held constant.
